(19) United States
(12) Patent Application Publication
(10) Pub. No.: US 2016/0142194 A1
(43) Pub. Date: May 19, 2016

(54) MOBILE STATION

(71) Applicant: NTT DOCOMO, INC., Tokyo (JP)

(72) Inventors: Tooru Uchino, Tokyo (JP); Hideaki Takahashi, Tokyo (JP); Wuri Andarmwanti Hapsari, Tokyo (JP)

(73) Assignee: NTT DOCOMO, INC., Tokyo (JP)

(21) Appl. No.: 14/900,630

(22) PCT Filed: Jun. 20, 2014
(86) PCT No.: PCT/JP2014/066421

§ 371 Date: Dec. 22, 2015

(30) Foreign Application Priority Data
Jun. 27, 2013 (JP) 2013-134643

(51) Int. Cl. H04L 5/00; H04W 76/04

(52) U.S. Cl. CPC H04L 5/0055; H04W 76/046

(57) ABSTRACT

A delay in transmission of “RRC connection reconfiguration complete” is avoided during execution of “Inter-eNB CA”. A mobile station UE according to the present invention includes a RRC message processing unit 12 configured to, when “RRC connection reconfiguration #1” is received from the radio base station eNB#1 and thereafter “RRC connection reconfiguration #2” is received from the radio base station eNB#2, perform processing for the “RRC connection reconfiguration #2” after completing transmission of “RRC connection reconfiguration complete” responding to the “RRC connection reconfiguration #1”.

### TECHNICAL FIELD

The present invention relates to a mobile station.

### BACKGROUND ART

In Release-10 of LTE (Long Term Evolution), CA (Carrier Aggregation) was introduced as control for achieving broadband communications beyond 20 MHz while maintaining “backward compatible”.

The CA is capable of achieving high throughput by performing communications with multiple (a plurality of) CCs (Component Carriers) aggregated.

The CA (“Intra-eNB CA”) in LTE Release-10, however, has a constraint in which CCs that can be aggregated should be under the same radio base station eNB as illustrated in FIG. 4.

For this reason, when a telecommunication carrier desires to implement the CA, the telecommunication carrier is always required to make network deployment such that CCs can be located under the same radio base station eNB. This poses a problem of making flexible network deployment difficult.

In order to solve this problem, as one of techniques for “SCE (Small Cell Enhancement)” in LTE Release-12 and beyond, “Inter-eNB CA” has been studied with the view of introduction. The “Inter-eNB CA” is CA performed with CCs under different radio base stations eNBs aggregated as illustrated in FIG. 5.

As illustrated in a part (a) in FIG. 6, the existing “Intra-eNB CA” is configured such that a single radio base station eNB always transmits an RRC (Radio Resource Control) message.

In contrast to this, “Inter-eNB CA”, has been studied such that radio base stations eNBs can transmit their respective RRC messages as illustrated in a part (b) of FIG. 6 (For example, see Non-patent document 1).

For example, each radio base station eNB is expected to directly send a mobile station UE an RRC message for setting or changing the configuration specific to the radio base station eNB (the configuration is, for example, PUCCH (Physical Uplink Control Channel) resource, SRS (Sounding Reference Symbol) resource, or the like). Accordingly, it is expected that there is a possibility that the mobile station UE will simultaneously receive different RRC messages from different radio base stations eNBs.

### PRIOR ART DOCUMENT

### Non-Patent Document

Non-patent document 1: 3GPP Contribution Document R2-131673

### SUMMARY OF THE INVENTION

In this connection, if the mobile station UE receives different messages of “RRC connection reconfiguration” from different radio base stations eNBs at almost the same time, the mobile station UE has a problem in that the mobile station UE may not be able to send “RRC connection reconfiguration complete” in response to the previously-received “RRC connection reconfiguration” depending on a content in the later-received “RRC connection reconfiguration”.

In one example of the above problem, if frequency switching processing on a radio communication unit is needed to process the later-received “RRC connection reconfiguration” (for example, “Scell addition/removal” or the like), the mobile station UE may not be able to send “RRC connection reconfiguration complete” in response to the previously-received “RRC connection reconfiguration” until the processing for the later-received “RRC connection reconfiguration” is completed.

Note that, if the transmission of “RRC connection reconfiguration complete” is delayed, a problem arises in that the radio base station eNB and the mobile station UE have state inconsistency at an RRC level for a longer period, because the radio base station eNB cannot know whether or not the mobile station UE completes the processing for “RRC connection reconfiguration” corresponding to the delayed “RRC connection reconfiguration complete”.

Therefore, the present invention has been made in view of the foregoing problems, and has an objective to provide a mobile station capable of avoiding a transmission delay of “RRC connection reconfiguration complete” while performing “Inter-eNB CA”.

### Means for Solving the Problem

In summary, a first feature of the present invention is a mobile station configured to be able to perform carrier aggregation using a cell under a first radio base station and a cell under a second radio base station, the mobile station including a processing unit configured to, when a first RRC message is received from the first radio base station and thereafter a second RRC message is received from the second radio base station, process the second RRC message after completing transmission of a processing complete message responding to the first RRC message.

### BRIEF DESCRIPTION OF THE DRAWINGS

FIG. 1 is an overall configuration diagram of a mobile communication system according to a first embodiment of the present invention.

FIG. 2 is a functional block diagram of a mobile station according to the first embodiment of the present invention.

FIG. 3 is a flowchart illustrating an operation of the mobile station according to the first embodiment of the present invention.

FIG. 4 is a diagram for explaining Intra-eNB CA.

FIG. 5 is a diagram for explaining Inter-eNB CA.

FIG. 6 is a diagram for explaining transmission of an RRC message in Intra-eNB CA and transmission of RRC messages in Inter-eNB CA.

### MODE FOR CARRYING OUT THE INVENTION

### Mobile Communication System According to First Embodiment of the Invention

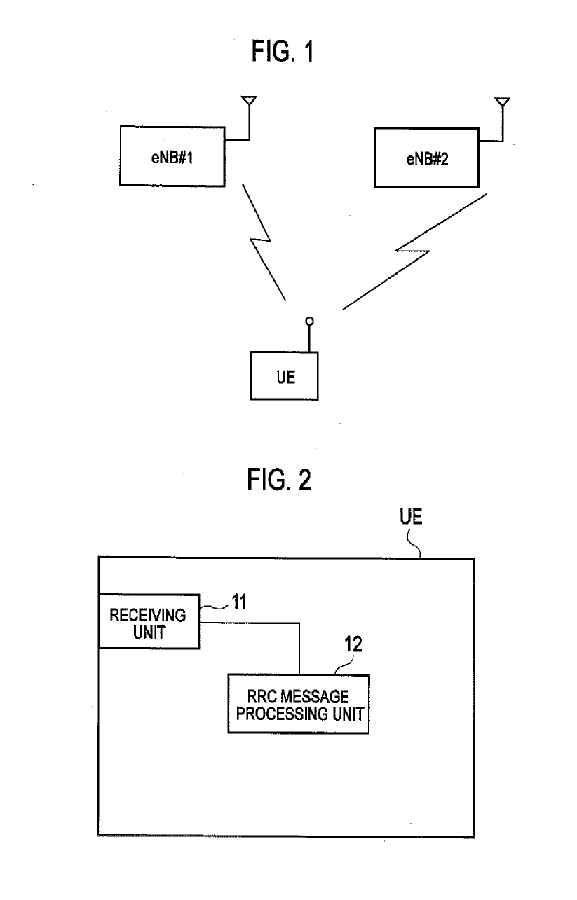

With reference to FIGS. 1 to 3, description is provided for a mobile communication system according to a first embodiment of the present invention.

The mobile communication system according to the present embodiment is an LTE-Advanced mobile communication system, and includes a radio base station eNB#1 and a radio base station eNB#2 as illustrated in FIG. 1.

In the mobile communication system according to the present embodiment, a mobile station UE is configured to be able to perform “Inter-eNB CA” by using a cell under the radio base station eNB#1 and a cell under the radio base station eNB#2.

As illustrated in FIG. 2, the mobile station UE according to the present embodiment includes a receiving unit 11 and an RRC message processing unit 12.

The receiving unit 11 is configured to receive various kinds of messages transmitted from the radio base station eNB#1 and the radio base station eNB#2.

For example, the receiving unit 11 is configured to receive an RRC message #1 (for example, “RRC connection reconfiguration #1”) from the radio base station eNB#1 and an RRC message #2 (for example, “RRC connection reconfiguration #2”) from the radio base station eNB#2 while the mobile station UE is performing “Inter-eNB CA” using a cell under the radio base station eNB#1 and a cell under the radio base station eNB#2. Here, the RRC message #1 and the RRC message #2 are different RRC messages.

The RRC message processing unit 12 is configured to process RRC messages received by the receiving unit 11.

For example, there is a case where the mobile station UE receives “RRC connection reconfiguration #1” from the radio base station eNB#1 and thereafter receives “RRC connection reconfiguration #2” from the radio base station eNB#2 during execution of “Inter-eNB CA” using the cell under the radio base station eNB#1 and the cell under the radio base station eNB#2. To deal with this case, the RRC message processing unit 12 is configured to process the “RRC connection reconfiguration #2” after completing transmission of “RRC connection reconfiguration complete” in response to the “RRC connection reconfiguration #1”.

Here, the RRC message processing unit 12 may be configured to determine that the transmission of the “RRC connection reconfiguration complete” responding to the “RRC connection reconfiguration #1” is completed when the “RRC connection reconfiguration complete” is mapped to a transport block (at a timing when the “RRC connection reconfiguration complete” is outputted to a not-illustrated radio communication unit included in the mobile station UE).

Instead, the RRC message processing unit 12 may be configured to determine that the transmission of the “RRC connection reconfiguration complete” responding to the “RRC connection reconfiguration #1” is completed, when “MAC-ACK” responding to MAC-PDU to which the “RRC connection reconfiguration complete” is mapped is received.

Otherwise, the RRC message processing unit 12 may be configured to determine that the transmission of the “RRC connection reconfiguration complete” responding to the “RRC connection reconfiguration #1” is completed, when “RLC-ACK” responding to RLC-PDU to which the “RRC connection reconfiguration complete” is mapped is received.

As another option, the RRC message processing unit 12 may be configured to determine that the transmission of the “RRC connection reconfiguration complete” responding to the “RRC connection reconfiguration #1” is completed, when a predetermined time passes after the transmission of the “RRC connection reconfiguration complete”.

Here, the aforementioned predetermined period may be notified of by a network (the radio base station eNB#1 or the radio base station eNB#2).

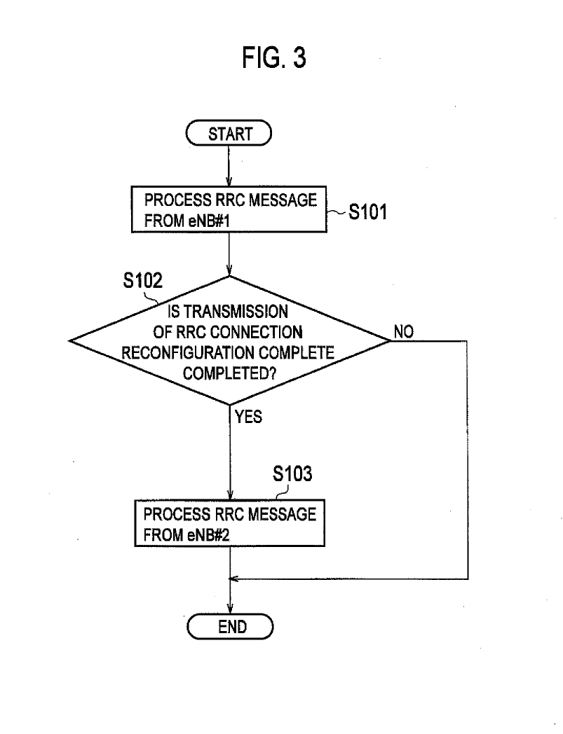

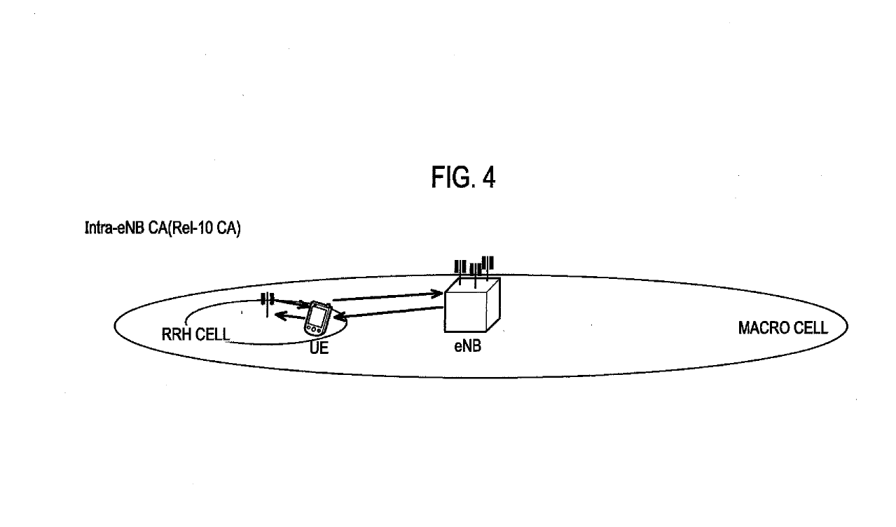

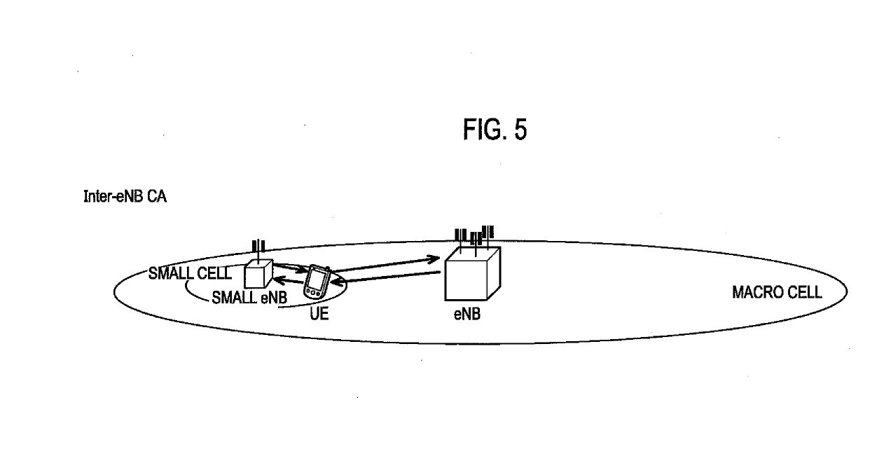

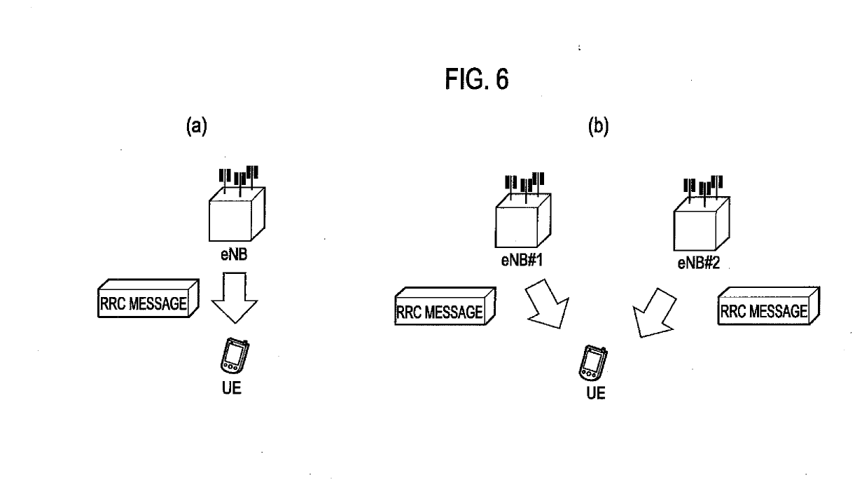

Hereinafter, with reference to FIG. 3, description is provided for an operation of the mobile communication system according to the present embodiment, or more specifically an operation of the mobile station UE according to the present embodiment.

As illustrated in FIG. 3, during execution of “Inter-eNB CA” using the cell under the radio base station eNB#1 and the cell under the radio base station eNB#2, the mobile station UE performs processing for “RRC connection reconfiguration #1” transmitted from the radio base station eNB#1 in step S101.

If the mobile station UE completes the transmission of “RRC connection reconfiguration complete” responding to the “RRC connection reconfiguration #1” in step S102, the mobile station UE performs processing for “RRC connection reconfiguration #2” transmitted from the radio base station eNB#2 in step S103.

Meanwhile, if the mobile station UE does not complete the transmission of “RRC connection reconfiguration complete” responding to the “RRC connection reconfiguration #1” in step S102, this operation is terminated.

The foregoing feature of the present embodiment may be expressed as follows.

In summary, a first feature of the present embodiment is a mobile station UE configured to be able to perform CA (carrier aggregation) using a cell under a radio base station eNB#1 (first radio base station) and a cell under a radio base station eNB#2 (second radio base station), the mobile station UE including an RRC message processing unit 12 configured to, when “RRC connection reconfiguration #1 (first RRC message)” is received from the radio base station eNB#1 and thereafter “RRC connection reconfiguration #2 (second RRC message)” is received from the radio base station eNB#2, process the “RRC connection reconfiguration #2” after completing transmission of “RRC connection reconfiguration complete (processing complete message)” responding to the “RRC connection reconfiguration #1”.

According to the first feature of the present embodiment, the mobile station UE processes the “RRC connection reconfiguration #2” after completing the transmission of the “RRC connection reconfiguration complete” responding to the “RRC connection reconfiguration #1”. For this reason, even if frequency switching processing on a radio communication unit is needed in order to process the “RRC connection reconfiguration #2”, a delay in transmission of the “RRC connection reconfiguration complete” responding to the “RRC connection reconfiguration #1” can be avoided.

In the first feature of the present embodiment, the RRC message processing unit 12 may be configured to determine that the transmission of the foregoing “RRC connection reconfiguration complete” is completed, when the “RRC connection reconfiguration complete” is mapped to a transport block.

According to this feature, the foregoing “RRC connection reconfiguration complete” can be transmitted without any trouble, even if the “RRC connection reconfiguration #2” needing the frequency switching processing on the radio communication unit is processed after the foregoing “RRC connection reconfiguration complete” is mapped to the transport block.

In the first feature of the present embodiment, the RRC message processing unit 12 may be configured to determine that the transmission of the foregoing “RRC connection reconfiguration complete” is completed, when “MAC-ACK (acknowledgement message)” responding to MAC-PDU to which the foregoing “RRC connection reconfiguration complete” is mapped is received.

According to this feature, the foregoing “RRC connection reconfiguration complete” can be transmitted without any trouble, even if the “RRC connection reconfiguration #2” needing the frequency switching processing on the radio communication unit is processed after reception of the “MAC-ACK” responding to the MAC-PDU to which the foregoing “RRC connection reconfiguration complete” is mapped.

In the first feature of the present embodiment, the RRC message processing unit 12 may be configured to determine that the transmission of the foregoing “RRC connection reconfiguration complete” is completed, when “RLC-ACK (acknowledgement message)” responding to RLC-PDU to which the “RRC connection reconfiguration complete” is mapped is received.

According to this feature, the foregoing “RRC connection reconfiguration complete” can be transmitted without any trouble, even if the “RRC connection reconfiguration #2” needing the frequency switching processing on the radio communication unit is processed after reception of the “RLC-ACK” responding to the RLC-PDU to which the foregoing “RRC connection reconfiguration complete” is mapped.

In the first feature of the present embodiment, the RRC message processing unit 12 may be configured to determine that the transmission of the foregoing “RRC connection reconfiguration complete” is completed, when a predetermined time passes after the transmission of the “RRC connection reconfiguration complete”.

According to this feature, the foregoing “RRC connection reconfiguration complete” can be transmitted without any trouble, even if the “RRC connection reconfiguration #2” needing the frequency switching processing on the radio communication unit is processed after the passage of the predetermined time from the transmission of the “RRC connection reconfiguration complete”.

In the first feature of the present embodiment, the aforementioned predetermined period may be notified of by a network.

According to this feature, the aforementioned predetermined period can be determined by the network with the capabilities of the mobile station UE or the like considered.

It should be noted that the foregoing operations of the mobile station UE and the radio base station eNB#1/eNB#2 may be implemented by hardware, may be implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the mobile station UE and the radio base station eNB#1/eNB#2. Otherwise, the storage medium and the processor may be provided as discrete components inside the mobile station UE and the radio base station eNB#1/eNB#2. Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire content of Japanese Patent Application No. 2013-134643 (filed on Jun. 27, 2013) is incorporated by reference in the present specification.

### INDUSTRIAL APPLICABILITY

According to the present invention, it is possible to provide a mobile station capable of avoiding a delay in transmission of “RRC connection reconfiguration complete” during execution of “Inter-eNB CA” as described above.

### EXPLANATION OF THE REFERENCE NUMERALS

eNB#1/eNB#2 radio base station
UE mobile station
11 receiving unit
12 RRC message processing unit

1. A mobile station configured to be able to perform carrier aggregation using a cell under a first radio base station and a cell under a second radio base station, the mobile station comprising a processing unit configured to, when a first RRC message is received from the first radio base station and thereafter a second RRC message is received from the second radio base station, perform processing for the second RRC message after completing transmission of a processing complete message responding to the first RRC message.

2. The mobile station according to claim 1, wherein the processing unit is configured to determine that the transmission of the processing complete message is completed, when the processing complete message is mapped to a transport block.

3. The mobile station according to claim 1, wherein the processing unit is configured to determine that the transmission of the processing complete message is completed, when an acknowledgement message responding to MAC-PDU to which the processing complete message is mapped is received.

4. The mobile station according to claim 1, wherein the processing unit is configured to determine that the transmission of the processing complete message is completed, when an acknowledgement message responding to RLC-PDU to which the processing complete message is mapped is received.

5. The mobile station according to claim 1, wherein the processing unit is configured to determine that the transmission of the processing complete message is completed, when a predetermined time passes after transmission of the processing complete message.

6. The mobile station according to claim 5, wherein the predetermined period is notified of by a network.
